(19) United States
(12) Patent Application Publication
(10) Pub. No.: US 2004/0124667 A1
(43) Pub. Date: Jul. 1, 2004

(54) Bumper device

(76) Inventors: Freerk Bosma, Schipluiden (NL); Joseph Hubert Antoon Marie Huibers, Eindhoven (NL)

Correspondence Address: YOUNG & THOMPSON, 745 SOUTH 23RD STREET 2ND FLOOR, ARLINGTON, VA, 22202

(21) Appl. No.: 10/469,606

(22) PCT Filed: Feb. 27, 2002
(86) PCT No.: PCT/NL02/00129

(30) Foreign Application Priority Data
Mar. 2, 2001 (NL) 1017483

(51) Int. Cl. B60R 19/18

(52) U.S. Cl. 296/187.04

(57) ABSTRACT

A device, intended as a buffer element (1) for collision with pedestrians, comprising absorption elements tuned to each other in position and rigidity. The absorption elements are located, in a condition when fitted on a vehicle, at a lower position located under knee-height, at a middle position located at knee-height and at an upper position located above knee-height, respectively. The absorption elements comprise a shell (2) reaching from the lower position, while enclosing a deformation space (9), to at least the upper position. The shell (2) comprises fastening means for attachment to the vehicle. Upon collision with a pedestrian, the shell (2) forms an impact surface effecting over a relatively large surface, a uniform acceleration of the leg of the pedestrian. Preferably, the absorption elements comprise, upon collision, a relatively high initial rigidity and deform over a relatively long path while maintaining a relatively constant rigidity.

The invention relates to a device, destined as buffer element for collision with pedestrians, comprising absorption elements tuned to each other in position and rigidity, which, in a condition when fitted onto a vehicle, are located, respectively, at a lower position situated under knee-height, at a middle position situated at knee-height and at an upper position situated above knee-height.

Such a device is known from the French patent specification 79,00123. In this patent, a vehicle is described, provided with such a device, in which three collision zones are identified which are related in a particular manner as to rigidity and position. Due to such a relation, the impact on the knee is kept limited. This device describes how, for a pedestrian, the consequences of a collision with a car can be kept limited. However, the device has drawbacks because, upon collision, the impact on the pedestrian, in particular on his leg and knees is still unacceptably high. In particular, the device does not meet the directives prescribed for collision properties of modern cars. It is anticipated that these directives will become legal requirements and contain criteria which prescribe the maximum forces, accelerations, moments, angles and displacements acceptable to legs and knee joints. For these criteria and a description of the term of knee-height, reference is made to the report of the Working Group 17 of the European Enhanced Vehicle Safety Committee: “Improved Test Methods to Evaluate Pedestrian Protection Afforded by Passenger Cars”, however, without this being considered as limitative to the invention.

The object of the invention is to form a device which constitutes an improvement over the known, and which meets the above-mentioned directives.

This object is achieved with a device of the type mentioned in the opening paragraph, wherein the absorption elements comprise a shell reaching from the lower position, while enclosing a deformation space, to at least the upper position, which shell comprises fastening means for attachment to the vehicle so that the shell, upon collision with a pedestrian, forms an impact surface which, over a relatively large surface, effects a uniform acceleration of the leg of the pedestrian. With the device according to the invention, the advantage is achieved that the forces are transmitted to a much larger leg surface than formerly, the presence of a free deformation space allowing a deformation of the shell such, that the impact surface can be formed as advantageously as possible.

Preferably, the rigidity is chosen such that, compared to conventional absorption elements, upon collision, at least some absorption elements have a relatively high initial rigidity and deform over a relatively long path with a relatively constant rigidity. Thus, it is achieved that initially, the acceleration of the leg increases strongly without, however, the maximally acceptable values being exceeded. The value of the rigidity can then be selected in relation to the maximum path of deformation and the shape of the shell: if the maximum path of deformation is relatively long, the rigidity can be relatively lower. What is meant in this context by path of deformation is the transverse distance between two planes orientated perpendicularly to the direction of movement of a collision, with one plane touching the absorption element before impact and the other plane touching the absorption element after impact. Preferably, the absorption elements have a section and rigidity which virtually continuously merge into each other such, that the impact surface at a collision expands virtually continuously over the length of the leg. Thus, it is made possible that at collisions with a pedestrian at up to 40 kilometers an hour, the maximum accelerations which are exerted on his legs remain below the acceptable values and the lateral bending angle and the shearing displacement of the knee remain limited.

To achieve favorable acceleration values, the shell has, in a condition when fitted on a vehicle, at the location of the middle position, a relatively smaller rigidity and a relatively longer path of deformation than at the location of the lower position.

In a condition when fitted on a vehicle, the shell preferably exhibits, in the part located above the middle position, a relatively smaller path of deformation than in the part located at the middle position. Preferably, the fastening means engage the circumferential edges and a part of the shell located in front of the bumper beam of the vehicle.

In a preferred embodiment, the desired rigidity properties of the device are realized in that the absorption elements located at the lower position comprise a crumple plate strengthened with longitudinal ribs which, in a condition when fitted on a vehicle, extend rearwards at the underside of the vehicle. The crumple plate can then comprise a fastening beam at the rear side for attachment to the vehicle.

In a further preferred embodiment the absorption elements located at the middle position comprise a resilient U-section which can be fastened to the front side of a bumper beam of a vehicle, while the fastening means comprise the longitudinal sides of the U-section extending along the bumper beam. This U-section cooperates with the shell and, at the location of the bumper beam, provides for the desired rigidity and deformation properties. The bumper beam can be designed to exhibit optimal collision properties relative to pegs or other car bumpers. For such an impact test (also called pendulum test), reference is made to the regulation number ECE R42 of July 1994, known in the car industry. In turn, the bumper beam forms part of the vehicle frame, which, itself, is also arranged to exhibit (in heavy collisions) collision properties which are as favorable as possible.

The device can comprise headlight housings integrated in the shell, the U-section comprising weakenings positioned on both sides outside the center for compensating the rigidity resulting from the headlight housings. In the shell, longitudinal reinforcements can be provided to prevent vibrations as a result of engine vibrations or driving. The invention further relates to a vehicle, provided with a device according to at least one of the above-mentioned aspects.

The invention will be further elucidated with reference to the drawings. In the drawing:

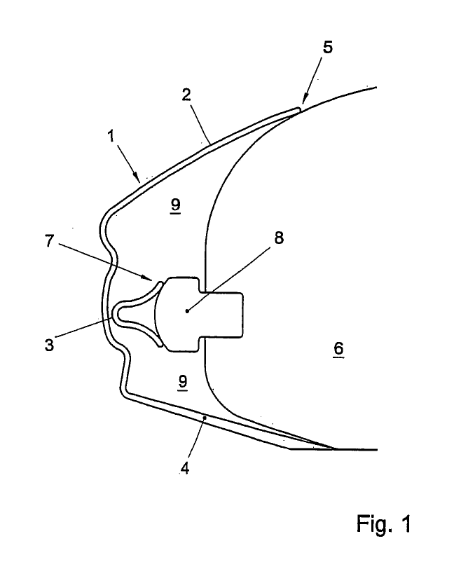

FIG. 1 shows a side view of the device according to the invention, visualizing a U-section and bumper beam;

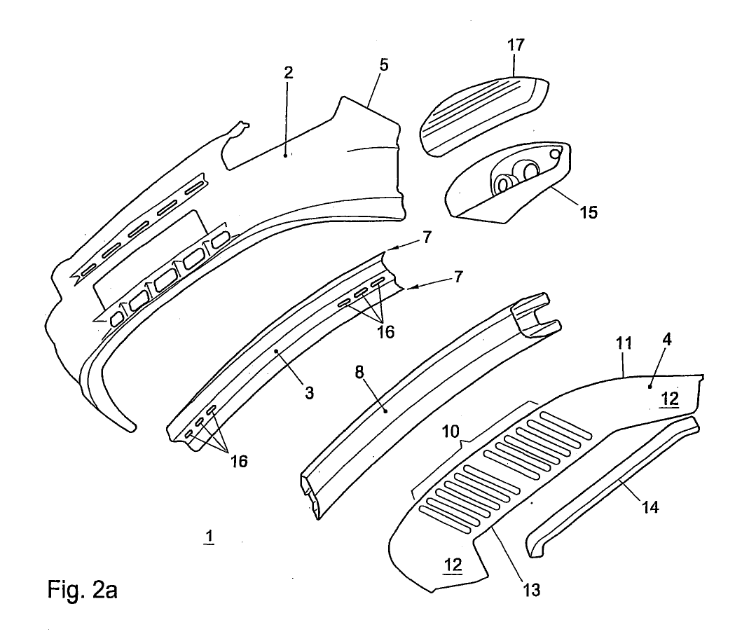

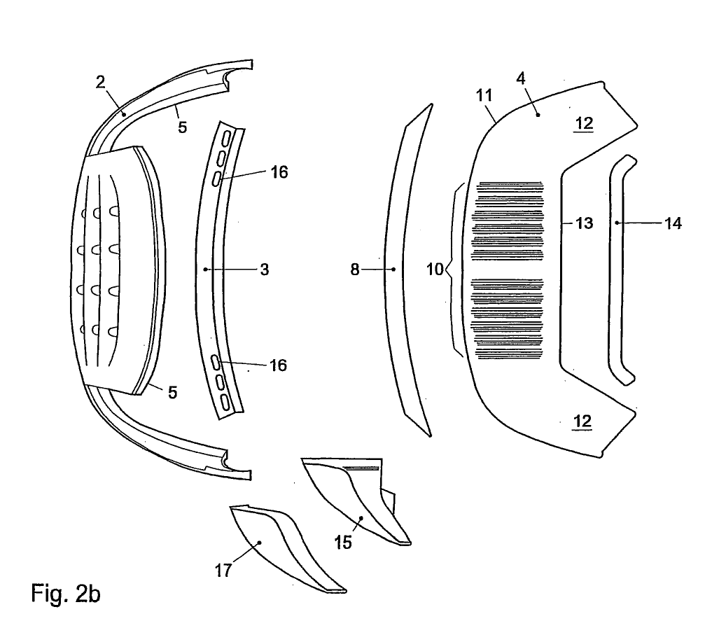

FIG. 2a shows a perspective view with parts disassembled of the device according to the invention from the lower side;

FIG. 2b shows a perspective view in taken apart parts of the device of FIG. 2a from the top side;

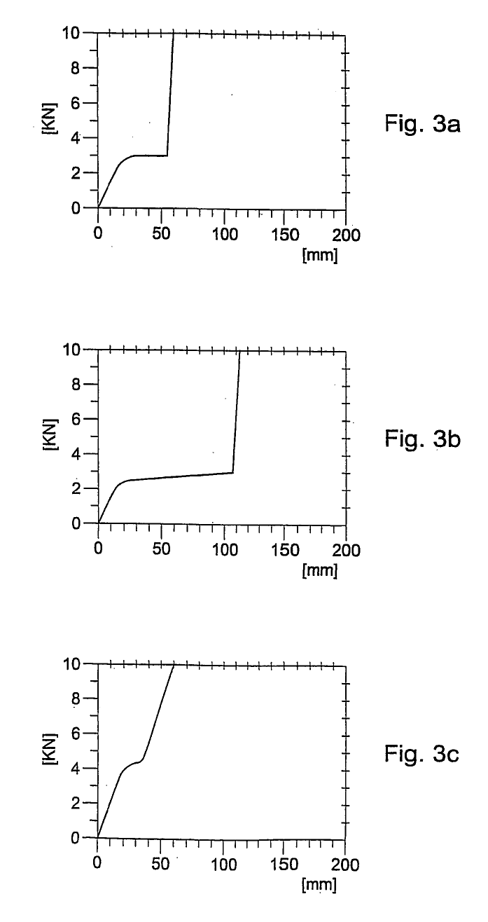

FIG. 3 shows a general diagram in which the results are shown of the deformation characteristics of the upper, middle and lower zone, respectively, of the device according to the invention;

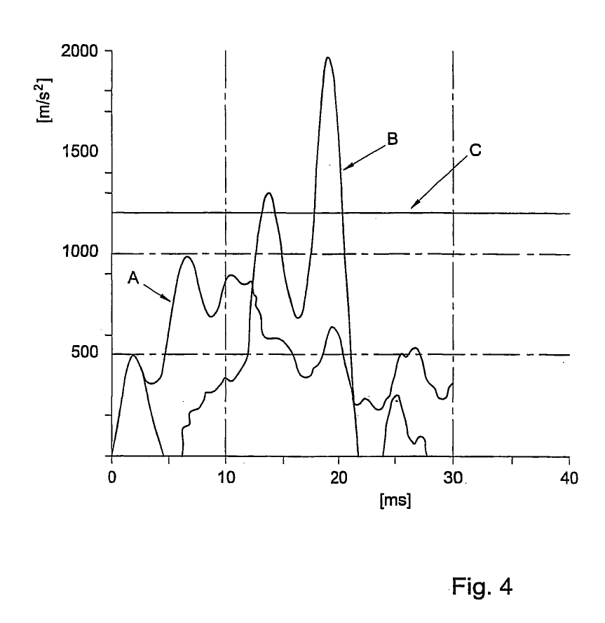

FIG. 4 shows the effect of the U-section on the acceleration of the leg;

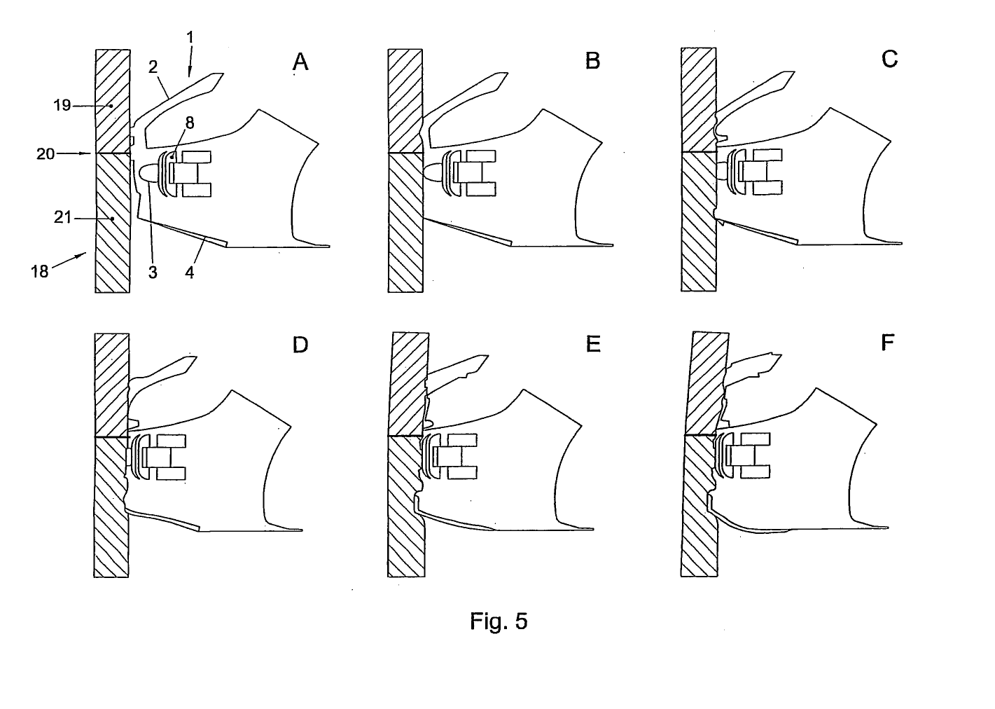

FIG. 5 shows a simulation of the deformation of the device according to the invention, after impact, with a leg on the center line, at, respectively, 0, 3, 6, 9, 12 and 15 ms.

In the Figures, identical or corresponding parts are designated with identical reference numerals.

In the following, the device will be designated as bumper, which is to be understood to mean that a bumper is involved which is intended as a buffer element upon collision with a pedestrian. The orientations such as front, back, below and above are intended as indications of the respective side of the bumper, if this is fitted onto a car. The bumper 1 consists of a shell 2 of a resilient plastic, for instance polypropylene. The plastic is selected because of its favorable deformation properties, in particular its capacity to bend or stretch while the formation of fracture surfaces is limited. Such fracture surfaces are disadvantageous to the rigidity of the bumper and often exhibit a visually unattractive white discoloration. In a practical embodiment, a polypropylene was used whose parameters can be specified as follows: density varying from 800-1300 kg/m³ with a preference for 1050 kg/m³; Poisson ratio varying from 0.2-0.4 with a preference for 0.3; elastic modulus varying from 1.0-2.0 E9 N/m² with a preference for 1.45 E9 N/m² and stress at yield varying from 1.0-2.5 E7 N/m² with a preference for 1.5 E7 N/m². In the plastic area, the breaking strain is considerable, preferably, typically, much greater than 100%. The shell 2 comprises absorption elements in the form of a U-section 3 and a crumple plate 4. In the represented embodiment, the U-section 3 and the crumple plate 4 are also of polypropylene. The crumple plate 4 supports and carries the shell 2 at the bottom side and is located at a position situated under knee-height. The U-section 3 is hidden from view by the shell 2; the shell 2 determines the front view of the vehicle. At the circumferential edges 5 of the shell 2, the bumper 1 is fitted on the schematically represented vehicle 6. As is represented in FIG. 1, the shell 2 reaches to at least a part of the front of the bonnet of the vehicle, in particular, as is also clear from the following Figures, the shell 2 reaches to a position located above knee-height. The U-section is then approximately at knee-height. The U-section 3 is resilient and, due to the selected shape, can, upon impact, deform over a relatively long path at a relatively constant rigidity. This also includes a limited increase, however, without this suddenly rising to relatively much higher values. The U-section 3 is attached, by the longitudinal sides 7, to the front side of a bumper beam 8, which, in turn, forms a part of the vehicle. At the front of the section 3, the part of the shell located in front of the bumper beam 8 follows the shape of the section 3 and is attached thereto. As a result, the profile 3, at the location of the knee, contributes to the rigidity of the shell. In FIG. 1, the contour of the vehicle is schematically represented, in reality, the shape of the deformation space 9 can be considerably different. This deformation space 9 has as a function that it gives the shell room to deform, by offering an escape for deforming absorption material. As has, for instance, already been illustrated with the section 3, the deformation space can, optionally, be partly filled with absorption elements and consist of several cavities separated from each other.

In the FIGS. 2a en 2b, the bumper 1 is represented with parts disassembled, viewed from the bottom side and the top side, respectively. In particular the crumple plate 4 has been represented therein, with the reinforcement ribs 10. The front of the crumple plate 4 has a round contour line 11, which follows the contour of the underside of the shell 2 and forms the connection therewith. The crumple plate 4 further comprises wings 12 extending rearwards, and an inner contour receding forward again, having a straight back part 13 which can be connected to the fastening beam 14. This fastening beam 14 secures the rear part of the crumple plate, so that the absorbing action of the plate 4 is maximal. Further, the headlight housings 15 integrated in the shell 2 are represented. The headlight housings 15 can be fixedly connected to the shell 2, but this is not required. The headlight housings 15 form an integrated part of the bumper, in the sense that the deformation characteristics of the shell 2 have been tuned thereto. To that end, the U-section 3 comprises on opposite sides off-center weakenings in the form of recesses 16 for compensating the rigidity resulting from the headlight housings 15. The headlight housings are screened off by transparent plates 17 of polycarbonate.

In FIG. 3, the optimal deformation characteristics of the bumper 1 according to the preceding FIGS. 1 and 2 are indicated. Here, a distinction is made into three zones, namely (FIG. 3a) the part of the bumper above knee-height, i.e. the part of the bumper reaching rearwards over a part of the bonnet; the zone at knee-height (FIG. 3b), formed by the combination of the shell 2 and the U-section 3 mounted on the bumper beam 8; and the part under it (FIG. 3c) approximately at the height of the shin, also called spoiler part. In the FIGS. 3a-3c, the reactive force is indicated in kN upon deformation, plotted against the deformation path in mm. It can be seen in the Figures that, in a condition when fitted on a vehicle, at the location of bumper beam (the U-section) the shell has a relatively lower rigidity and a relatively longer path of deformation than at the location of the spoiler. The sharply ascending curve of FIG. 3c indicates that the rigidity of the bumper is relatively the greatest at the location of the spoiler part. Further, it follows from FIGS. 3a-3c, that the shell, in a condition when fitted on a vehicle, in the part situated above the middle position, has a relatively smaller path of deformation than in the part at the location of the middle position.

FIGS. 3a-c further indicate that at deformation, the force of deformation rises relatively rapidly, whereupon, for the part at knee-height and thereabove, the deformation occurs over a relatively long path with a relatively constant force of deformation. The deformation characteristics of the bumper are therefore optimally tuned to each other; in particular, it is achieved that onto a leg of a pedestrian who collides with the bumper, forces are applied which are below the maximally acceptable values. The material properties which can be derived from FIGS. 3a-3c serve as an illustration; also other rigidity characteristics, deviating, for example, up to approximately 30% from these values, can be used.

By way of example, FIG. 4 represents the calculated acceleration which is applied onto a leg, in time. In the Figure, the results of two situations are represented: one line A relates to the acceleration applied onto a leg in time, upon collision with a bumper according to the invention; the other line B relates to a collision of the leg, if the collision takes place without the energy absorbing U-section 3 being present between the bumper beam 8 and the shell 2. The horizontal line C indicates the norm which was deemed maximally acceptable in the test, which is 1200 m/s² (120 g). The above-mentioned directives of Working Group 17 prescribe, for that matter, a maximum value of 150 g. From the Figure it appears that through the bumper according to the invention, initially, the acceleration increases strongly, but remains below a maximum value (A). In the comparative example B it is shown that after onset, the acceleration drops considerably, and then mounts to beyond the maximum value (C).

Finally, in FIGS. 5a-5f a simulation is represented, which shows the deformation of the bumper according to the invention, at, respectively, 0, 3, 6, 9, 12 and 15 ms after impact at a vehicle speed of 40 km/h. There, reference numeral 18 indicates a dummy of a human leg; built up from an upper leg 19, a knee 20 and a lower leg 21. The bumper 1 hits the leg at the location of the knee 20 and starts to deform. It can be seen in the Figures that the impact surface expands over the length of the leg. The largest deformation occurs at the location of the knee 20; the shell 2 and the U-section 3, respectively, then deform over a relatively long deformation path terminating against the bumper beam 8. FIGS. 5a-5f also show the deformation of the crumple plate 4, which starts to deform strongly from 3 ms after impact. From the FIGS. 5a-f, it can be derived that during deformation of the shell, because of the relative position and rigidity distribution of the different absorption elements, and because of the presence of free space, material of the shell is pushed inwards and then upwards.

Although the invention has been described on the basis of an exemplary embodiment, it is clear that it is not limited thereto, but that it can comprise all sorts of variations and modifications. For instance, the shape of the absorption elements can be varied to obtain the desired rigidity characteristics. The absorption elements can form an integrated part of the shell. It is also possible that the deformation space be provided with additional absorption material. Such variations are understood to fall within the range and scope of protection of the following claims.

1. A device, intended as a buffer element for collision with pedestrians, comprising absorption elements tuned to each other in position and rigidity, located, respectively, in a condition when fitted on a vehicle, at a lower position under knee-height, at a middle position at knee-height and at an upper position above knee-height, characterized in that the absorption elements comprise a shell extending from the lower position, while enclosing a deformation space, to at least the upper position, which shell comprises fastening means for attachment to the vehicle, so that the shell, upon collision with a pedestrian, forms an impact surface effecting a uniform acceleration of the leg of the pedestrian over a relatively large surface.

2. A device according to claim 1, characterized in that at least some absorption elements upon collision have a relatively high initial rigidity and deform over a relatively long path with a relatively constant rigidity.

3. A device according to claim 1 or 2, characterized in that the absorption elements have a profile and rigidity merging virtually continuously into each other such, that upon collision, the impact surface expands in a virtually continuous manner over the length of the leg.

4. A device according to at least one of the preceding claims, characterized in that, in a condition when fitted on a vehicle, at the location of the middle position, the shell has a relatively smaller rigidity and a relatively longer deformation path than at the location of the lower position.

5. A device according to at least one of the preceding claims, characterized in that, in a condition when fitted on a vehicle, in the part located above the middle position, the shell has a relatively shorter deformation path than in the part located at the middle position.

6. A device according to at least one of the preceding claims, characterized in that the fastening means engage the circumferential edges and a part of the shell located in front of the bumper beam of the vehicle.

7. A device according to at least one of the preceding claims, characterized in that absorption elements located at the lower position comprise a crumple plate strengthened with longitudinal ribs, which, in a condition when fitted on a vehicle, extend rearwards at the underside of the vehicle.

8. A device according to claim 7, characterized in that at the rear side, the crumple plate comprises a fastening beam for attachment to the vehicle.

9. A device according to any one of the preceding claims, characterized in that the absorption elements located at the middle position comprise a resilient U-section which can be attached to the front of a bumper beam of a vehicle, and that the fastening means comprise the longitudinal sides of the U-section extending along the bumper beam.

10. A device according to at least one of the preceding claims, characterized in that the bumper beam is designed to exhibit optimal collision properties in relation to pegs or other car bumpers.

11. A device according to claim 9 or 10, characterized in that the device comprises headlight housings integrated in the shell and that the U-section on opposite sides off-center comprises weakenings for compensating the rigidity resulting from the headlights.

12. A device according to at least one of the preceding claims, characterized in that in the shell, longitudinal reinforcements are provided for the prevention of vibrations as a result of engine vibrations or driving.

13. A vehicle, provided with a device according to at least one of the preceding claims.
